(19) United States
(12) Patent Application Publication
(10) Pub. No.: US 2016/0016143 A1
(43) Pub. Date: Jan. 21, 2016

(54) APPARATUS FOR MANUFACTURING Si-BASED NANO-PARTICLES USING PLASMA

(71) Applicant: KOREA INSTITUTE OF ENERGY RESEARCH, Daejeon (KR)

(72) Inventors: Bo-Yun JANG, Daejeon (KR); Jin-Seok LEE, Daejeon (KR); Joon-Soo KIM, Daejeon (KR); Jeong-Boon KOO, Daejeon (KR)

(21) Appl. No.: 14/800,670

(22) Filed: Jul. 15, 2015

(30) Foreign Application Priority Data
Jul. 16, 2014 (KR) 10-2014-0090084
Jul. 16, 2014 (KR) 10-2014-0090085

(51) Int. Cl. B01J 19/08; B01J 19/12

(52) U.S. Cl. CPC B01J 19/088; B01J 19/126; B01J 2219/0805; B01J 2219/0871; B01J 2219/0869; B01J 2219/0875; B01J 2219/0877; B01J 2219/0879; B01J 2219/1206

(57) ABSTRACT

Disclosed herein is an apparatus for manufacturing silicon-based nanoparticles such as Si—C composite and SiOx using plasmas. An apparatus for manufacturing silicon-based nanoparticles in accordance with one embodiment of the present disclosure comprises a reaction chamber for providing a reaction space; a plasma torch for generating plasma to decompose silicon (Si) precursors and produce Si particles, provided on an upper portion of the reaction chamber; a cooling part for cooling Si particles supplied into the reaction chamber, provided within the reaction chamber; and a carbon material supplying part for supplying carbonaceous materials or carbon precursors into the reaction chamber.

### CROSS-REFERENCE TO RELATED APPLICATION

This application claims the benefit of Korean Patent Applications No. 10-2014-0090084 and No. 10-2014-0090085, filed on Jul. 16, 2014 in the Korean Intellectual Property Office, the disclosure of which is incorporated herein in its entirety by reference.

### BACKGROUND

1. Technical Field

The present disclosure relates to an apparatus for manufacturing Si-based nanoparticles such as Si—C composite and SiOx using plasma.

2. Description of the Related Art

Silicon nano-powders are known as materials widely applicable to various advanced electronic or optical fields. For example, in printable electronics, a nano-ink composition comprising silicon nano-powders is used in environmentally friendly process for forming a semiconductor layer for electrical or optical function. Recently, many studies have been made on silicon having a high theoretical capacity as a negative electrode active material for a high capacity lithium-ion battery (4200 mAh/g) for replacing carbon. In particular, nano-sized silicon is one of the solutions to mitigate a large volume expansion (300 to 400%) of a silicon-based negative electrode occurring during charging and discharging of the battery, which causes a reduced service life. This is because nanoparticles are able to more efficiently withstand stresses and strains than microparticles.

However, sufficient buffering effect on the volume changes that occur during charging and discharging of the battery with nano-sized silicon alone cannot be obtained. Therefore, an appropriate mixing ratio and a uniform structural arrangement with carbon which is electrically conductive and has a structural buffering effect are required for the silicon nano-powders. When the silicon nano-powders are coated with a porous/amorphous carbon in a continuous process, an oxidation of a surface of the silicon can be prevented, whereby the initial irreversible capacity can be minimized while at the same time due to the buffering effect on the volume expansion of the silicon occurring during charging and discharging of the battery, the cycle life characteristics of the battery can be improved. For this particular purpose, there remains the need to prepare Si—C nanoparticles, SiOx nanoparticles, and the like.

In general, a method of producing silicon nano-powders includes solid phase synthesis, liquid phase synthesis, and a vapor phase synthesis. However, among these methods, the vapor phase synthesis, since therefrom a high reaction rate and a high purity of particles can be obtained, is preferred. More specifically, most preferred is such vapor phase synthesis using plasmas that can obtain nano-powders regardless of the phase of starting materials.

A further relevant reference to the present disclosure is made to a plasma nano-powder synthesis and a coating device and a method thereof disclosed in the Korean Laid-open Patent Publication No. 2012-0130039 (publication date: Nov. 28, 2012).

### BRIEF SUMMARY

One object of the present disclosure is to provide a manufacturing apparatus capable of uniformly producing silicon-based nanoparticles, more specifically Si—C composite nanoparticles, in a continuous process using a plasma torch.

Another object of the present disclosure is to provide a manufacturing apparatus capable of producing silicon-based nanoparticles, more specifically SiOx nanoparticles, using a plasma torch.

An apparatus for manufacturing silicon-based nanoparticles in accordance with one aspect of the present disclosure comprises a reaction chamber for providing a reaction space; a plasma torch for generating plasma to decompose silicon precursors and produce Si particles, provided on an upper portion of the reaction chamber; a cooling part for cooling Si particles supplied into the reaction chamber, provided within the reaction chamber; and a carbon material supplying part for supplying carbonaceous materials into the reaction chamber, wherein in the plasma torch, the Si precursors injected with plasma are dissociated and bonded to form Si particles through particle nucleation and nuclear growth, and wherein in the reaction chamber, the Si particles and the carbonaceous materials are complexed.

According to some embodiments, the carbon material supplying part is connected to the cooling part, such that the carbonaceous materials can be supplied through the cooling part.

According to some embodiments, this apparatus further comprises a particle trap for trapping silicon-based nanoparticles, provided at a lower portion of the reaction chamber. According to some embodiments, this apparatus further comprises a scrubber for treating an acid exhaust gas, provided at a lower portion of the particle trap.

Further, an apparatus for manufacturing silicon-based nanoparticles in accordance with another aspect of the present disclosure comprises a reaction chamber for providing a reaction space; and a plasma torch using a microwave as a plasma source, comprising a precursor gas inlet for injecting a silicon precursor gas, provided on an upper portion of the reaction chamber, and a swirl gas inlet for injecting a plasma gas in the form of swirl, wherein the plasma gas and an oxidizing gas are supplied into the swirl gas inlet to allow a source gas and the oxidizing gas to react along a vortex flow.

According to some embodiments, this apparatus further comprises an oxidizing gas supplying part for supplying the oxidizing gas into the swirl gas inlet.

According to some embodiments, this apparatus further comprises a cooling part for cooling particles produced in the reaction chamber, provided within the reaction chamber.

According to some embodiments, it is preferred that the swirl gas inlet is radially disposed around the precursor gas inlet, and is configured in such a way that the swirl gas can be injected toward the center of the plasma zone in a direction inclined inside at an angle of 25 to 45 degrees with respect to a vertical direction.

According to some embodiments, it is more preferred that the swirl gas inlet is allowed for the swirl gas to be injected at an angle of 5 to 15 degrees inside toward the center of a circle with respect to a planar tangential direction.

According to some embodiments, this apparatus further comprises a particle trap for trapping silicon-based nanoparticles, provided at a lower portion of the reaction chamber, and a scrubber for treating an acid exhaust gas, provided at a lower portion of the particle trap.

According to some embodiments, a Si nanoparticle forming process and a Si—C complexing process are performed in an integral reaction chamber, and the characteristics of Si nanoparticles and Si—C composite can be controlled based on a source input method and process conditions, such as a plasma power, a gas type, a flow rate, and a cooling gas. In this embodiment, advantageous is that a vacuum unit is not required, and thus the cost of the equipment can be reduced.

According to some embodiments, a larger volume of a high density plasma zone can be obtained and a residence time of reactive gas remaining in the plasma can be increased by concentrating the plasma on the reactor center by swirling the gas. By concentrating the plasma as such, an outer wall of the reactor can be protected from overheating, and the contamination of reagents caused by this outer wall can be prevented.

According to some embodiments, in the process of manufacturing SiOx nanoparticles, the x value may be varied in a range of 0.4 to 2.0 by controlling the flow rate of the oxidizing gas, where the x value indicates oxygen content.

Still another aspect of the present disclosure is to the use of the SiOx nanoparticles produced by the process according to the present disclosure in a negative electrode active material for a lithium secondary battery. In this embodiment, advantage of an excellent capacity retention rate can be provided.

### BRIEF DESCRIPTION OF THE DRAWINGS

The above and other objects or aspects, features and advantages of the present disclosure will become apparent from the following descriptions of the exemplary embodiments with reference to the accompanying drawings, in which:

FIG. 1 is a schematic diagram showing an apparatus for manufacturing a Si—C composite according to a first embodiment of the present disclosure.

FIG. 2 shows temperature distributions in a reactor before and after the injection of a cooling gas through a cooling part.

FIG. 3 shows plasma flame shapes before and after the injection of a cooling gas through a cooling part.

FIG. 4 is a perspective view of a cooling part according to an embodiment of the present disclosure.

FIG. 5 is two SEM images of Si nanoparticles produced in the process of manufacturing Si—C composite according to an embodiment of the present disclosure.

FIG. 6 shows XRD diffraction patterns of Si nanoparticles produced in the process of manufacturing Si—C composite according to an embodiment of the present disclosure.

FIG. 7 shows Raman spectra of Si—C composite produced in the process of manufacturing Si—C composite according to an embodiment of the present disclosure.

FIG. 8 is a graph showing the result of applying Si nanoparticles and Si—C composite produced using a manufacturing apparatus according to an embodiment of the present disclosure to a negative electrode active material for a lithium secondary battery.

FIG. 9 is a conceptual diagram showing an apparatus for manufacturing SiOx Nanoparticles according to a second embodiment of the present disclosure.

FIG. 10 shows two plasma shapes, (a) when plasma gas is injected in swirl mode, and (b) when plasma gas is injected in vertical mode.

FIG. 11 is a schematic block diagram illustrating an embodiment of a microwave plasma torch according to an embodiment of the present disclosure.

FIG. 12 is a schematic diagram showing a supply plane of a plasma gas in a microwave plasma torch according to an embodiment of the present disclosure.

FIG. 13 is two images showing the particle shapes according to a plasma injection mode.

FIG. 14 is a graph showing the internal temperature distributions in the microwave plasma reactor according to the present disclosure.

FIG. 15 is a graph showing the temperature distributions outside of the microwave plasma reactor according to the present disclosure.

FIG. 16 is three images showing the changes in the plasma shapes and lengths according to the flow rate of plasma gas and the flow rate of reactive gas.

FIG. 17 is SEM images showing a variety of shapes and sizes of SiOx nanoparticles produced by differentiating a reactive gas, a ratio of reactants, and a flow rate.

FIG. 18 is XRD results showing the crystallinity of SiOx produced according to the present disclosure.

FIG. 19 is a TEM image showing the microstructure of SiOx produced according to the present disclosure.

FIG. 20 is four graphs showing the characteristics of SiOx nanoparticles produced using the device and method according to the present disclosure.

FIG. 21 is a graph showing the capacity and performance of a secondary battery manufactured using SiOx, crystalline silicon, and amorphous SiO, respectively.

### BRIEF DESCRIPTION OF NUMBERS SHOWN IN THE DRAWINGS

110: reaction chamber
120: plasma torch
122: precursor gas inlet
124: swirl gas inlet
130: cooling part
140: carbon material supplying part
150: particle trap
160: scrubber

### DETAILED DESCRIPTION

Hereinafter, preferred embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure based on the principle that the inventor is allowed to define terms. Therefore, the description proposed herein is just a preferable example for the purpose of illustration only, and is not intended to limit the scope of the disclosure, so it should be understood that other equivalents and modifications could be made thereto without departing from the spirit and scope of this disclosure.

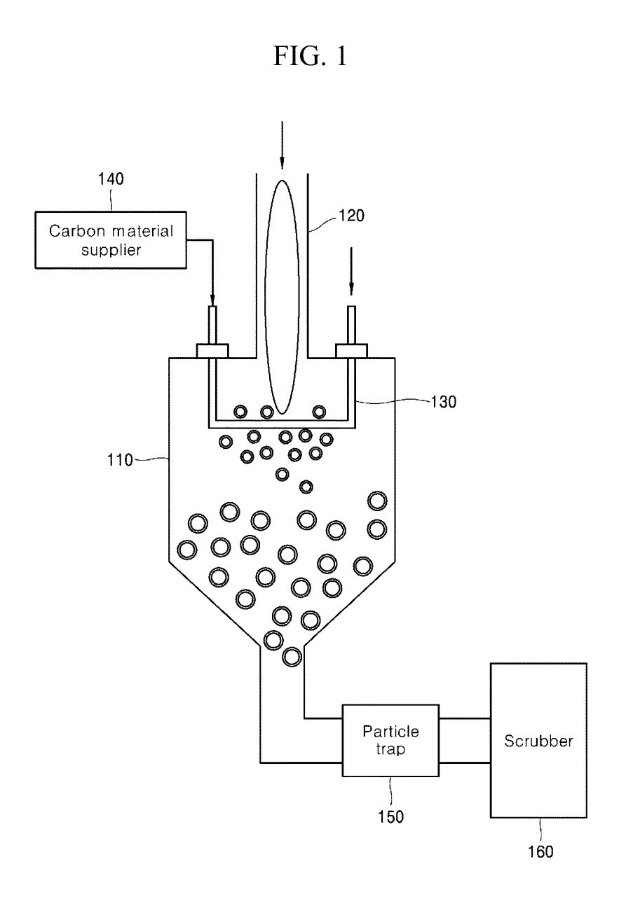

FIG. 1 is a conceptual view showing an apparatus for manufacturing silicon-based nanoparticles according to a first embodiment of the present disclosure, more specifically, shows an apparatus capable of producing Si—C composite nanoparticles.

As depicted, an apparatus for manufacturing Si—C composite according to the present disclosure includes a reaction chamber 110 for providing a reaction space, a plasma torch 120 for generating plasma to decompose silicon precursors and produce Si particles, a cooling part 130 for cooling the Si particles supplied thereto, provided within the reaction chamber 110, and a carbon material supplying part 140 for supplying carbonaceous materials into the reaction chamber 110.

The plasma torch 120 is provided on an upper portion of the reaction chamber 110, and the cooling part 130 is provided on a lower portion of the plasma torch 120.

Carbon material supplying part 140 is connected to the cooling part 130, and therefore carbonaceous materials can be supplied together with a cold gas.

In addition, at a lower portion of the reaction chamber 110, further provided are a particle trap 150 for trapping the Si—C particles, and a scrubber 160 for treating to neutralize an acid exhaust gas, connected to a lower portion of the particle trap 150.

The present disclosure is characterized in that the reaction chamber 110 is configured integrally with the plasma torch 120, such that Si—C composites can be produced uniformly in a continuous manner.

The silicon precursor supplied into the plasma torch 120 includes a solid-phase micro-Si particle, a liquid-phase SiCl₄, a gas-phase SiH₄, and the like.

The precursors are sufficiently and uniformly fined or gasified and then injected into the plasma torch with a plasma forming gas, such as argon or nitrogen. In addition, H₂ gas may be introduced together with the Si precursors as a carrier gas or reactive gas.

The plasma torch 120 can use a variety of plasma source. For example, the plasma source that can be used includes, but not limited to, an electron cyclotron resonance (ECR) plasma source, a reactive ion etching (RIE) source, a capacitively coupled plasma (CCP) source, and an inductively coupled plasma (ICP) source.

The ECR source is also known as microwave plasma, since in general the microwave is an energy source for plasma generation. ICP source can be operated in an electrodeless discharge mode that induces an electric field in the chamber by supplying a RF power to an induction coil, to thereby generate plasma. On the other hand, CCP source generates plasma in the chamber by an electric field generated by supplying a RF power to electrode plates.

The cooling part 130 is provided in the interior of the reaction chamber 110 for controlling, for example, the Si nanoparticles reaction and formation.

In the plasma torch 120, plasma is formed by a plasma source and a plasma forming gas (e.g., Ar and N₂), and silicon precursors injected therewith are dissociated and combined to form Si nanoparticles through the process of nucleation and nuclear growth. The Si nanoparticles grow between the plasma torch 120 and the cooling part 130, and microstructure such as grain size is controlled in the cooling part 130 into which a cooling gas is injected.

Further, carbonaceous materials are introduced into the cooling part 130 where a Si—C complexing process may be continuously performed.

The carbonaceous materials are supplied from the carbon material supplying part 140 to the cooling part 130.

The carbon material supplying part 140 can supply the carbonaceous materials, such as carbon nanotubes (CNT), carbon nanofibers (CNF), and graphite, to the cooling part 130. In addition, the carbon material supplying part 140 may supply a carbon precursor gas. The carbon precursor gas that may be used is an alcohol or a hydrocarbon-based gas.

A process for manufacturing Si—C composite according to another aspect of the present disclosure using the apparatus as mentioned above, comprises: supplying a Si precursor gas with a plasma forming gas into the reaction chamber 110, such that Si precursors injected with plasma may be dissociated and combined to form Si nanoparticles through the process of nucleation and nuclear growth, and supplying carbonaceous materials with a cooling gas to the cooling part 130 in the reaction chamber 110, thereby complexing the Si nanoparticles and the carbonaceous materials.

In this embodiment, the carbon precursor gas is further supplied to the cooling part, such that carbon coating over the Si—C composite can be achieved.

According to some embodiments of the apparatus and process for manufacturing Si—C composite of the present disclosure, the Si nanoparticle forming process and the Si—C complexing process are performed in an integral reaction chamber 110, and the characteristics of Si nanoparticles and the Si—C composite can be controlled following a source input method and process conditions, such as a plasma power, a gas type, a flow rate, and a cooling gas.

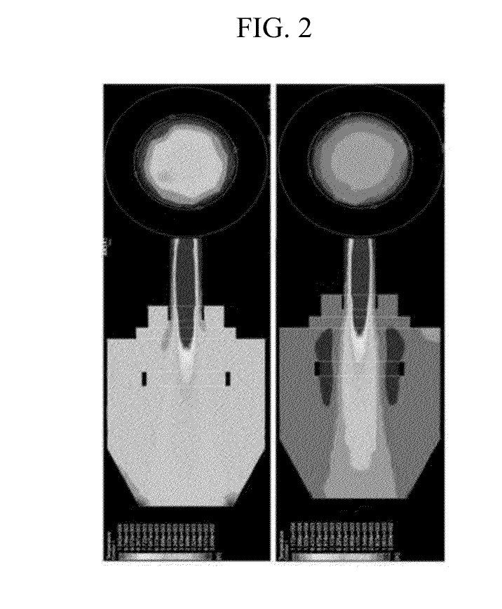

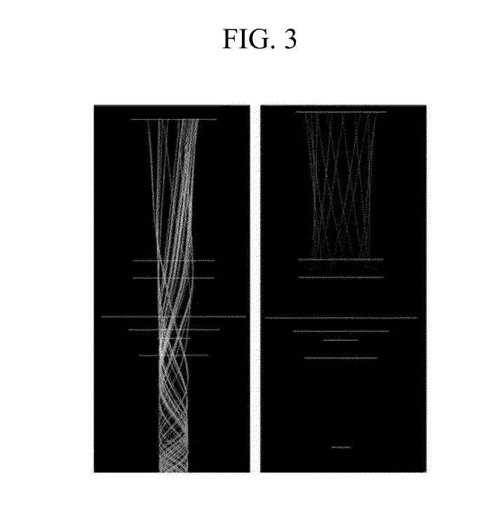

FIG. 2 shows temperature distributions in the reactor before and after the injection of a cooling gas through the cooling part, and FIG. 3 shows plasma flame shapes before and after the injection of a cooling gas through the cooling part.

Referring to FIG. 2, it can be seen that the injection of cooling gas reduces the total reactor temperature, as well as the temperature of an air flow effectively. In addition, referring to FIG. 3, it can be seen that the injection of cooling gas renders the plasma flame shorter and the shape thereof being deformed. This cooling gas plays an important role in efficient particle formation.

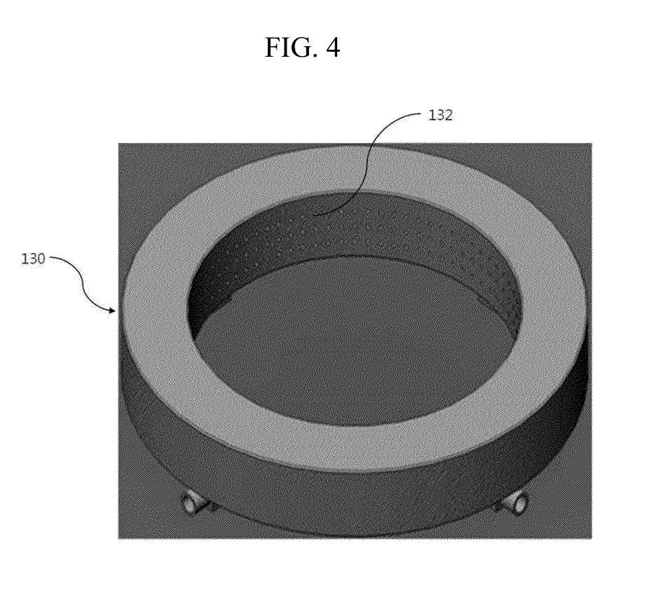

FIG. 4 is a perspective view of a cooling part according to an embodiment of the present disclosure.

The cooling part 130 is configured to inject the cooling gas and the carbonaceous materials into a lower portion of the plasma zone.

The cooling part 130 is substantially ring-shaped, and has spraying holes 132 formed on an inner surface thereof.

The spraying holes have a diameter range of 1 to 3 mm, and are formed at uniform intervals.

The cooling part 130 may be made of a suitable chemical resistant metal.

The cooling gas that can be injected through the cooling part 130 includes, but not limited to, nitrogen (N₂), argon (Ar), helium (He), hydrogen (H₂), air, and mixtures thereof.

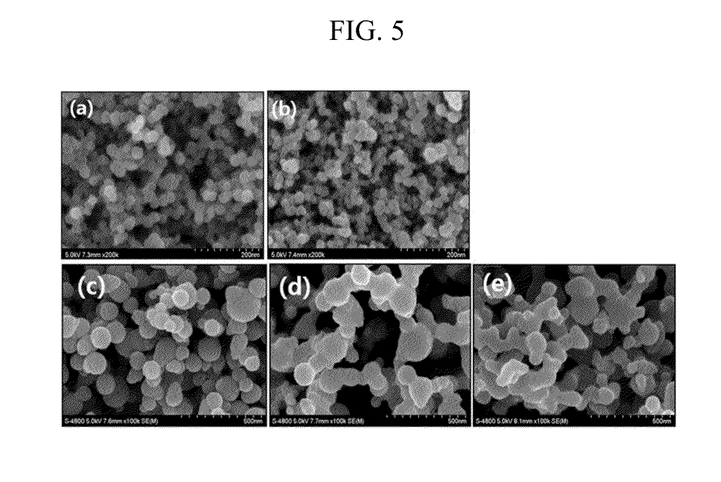

FIG. 5 is SEM images of Si nanoparticles produced in the process of manufacturing Si—C composite according to the present disclosure. Examples 1 and 2 demonstrated that the particle size can be controlled under the experimental conditions for controlling particle sizes with the apparatus for manufacturing nanoparticles using RF plasma, and relatively uniform particle sizes can be obtained as shown in FIGS. 5(a) and (b). In Examples 6, 7 and 8, the experimental conditions were employed for controlling necking phenomena between the particles by the apparatus for manufacturing nanoparticles using microwave plasma, and as shown in FIGS. 5(c) to (e), spherical nanoparticles, aggregates of the particles, ambiguous boundaries of the particles, and the like were seen depending on the proper ratios of the reactants.

Table 1 below indicates the characteristics of nanoparticles produced according to plasma source power, plasma forming gas, flow rate of injection gas, kinds of particle precursors, and flow rate of the precursors.

TABLE 1

| | Plasma | | | | | Flow rate | Characteristic |
|---|---|---|---|---|---|---|---|
| | energy | | Plasma | Injection | Particle | of | of |
| | source | Power | forming gas | gas | precursor | precursor | nanoparticle |
| EX. 1 | RF(ICP) | 300 W | Ar | Cooled Ar | SiH₄ | 5 ccm | Particle size |
| | | | 500 ccm | 300 ccm | (vapor) | | 25~30 nm |
| EX. 2 | RF(ICP) | 300 W | Ar | Cooled Ar | SiH₄ | 10 ccm | Particle size |
| | | | 500 ccm | 300 ccm | (vapor) | | 20~25 nm |
| EX. 3 | RF(ICP) | 300 W | Ar | Cooled Ar | SiH₄ | 20 ccm | Particle size |
| | | | 500 ccm | 300 ccm | (vapor) | | 15~20 nm |
| | | | | | | | Production |
| | | | | | | | yield |
| | | | | | | | below 50% |
| EX. 4 | RF(ICP) | 300 W | Ar | Cooled Ar | SiH₄ | 20 ccm | Production |
| | | | 400 ccm | 400 ccm | (vapor) | | yield |
| | | | | | | | 50~70% |
| EX. 5 | RF(ICP) | 300 W | Ar | Cooled Ar | SiH₄ | 20 ccm | Production |
| | | | 300 ccm | 500 ccm | (vapor) | | yield |
| | | | | | | | at least 70% |
| EX. 6 | Microwave | 3.0 kW | N₂ | Reactive | SiCl₄ | 1 ml/min | No necking |
| | (ECR) | | 25 SLPM | H₂ | (liquid) | @RT | between |
| | | | | 10 SLPM | | | particles |
| EX. 7 | Microwave | 3.0 kW | N₂ | Reactive | SiCl₄ | 2 ml/min | Necking |
| | (ECR) | | 25 SLPM | H₂ | (liquid) | @RT | between |
| | | | | 10 SLPM | | | particles |
| EX. 8 | Microwave | 3.0 kW | N₂ | Reactive | SiCl₄ | 3 ml/min | Severe |
| | (ECR) | | 25 SLPM | H₂ | (liquid) | @RT | necking |
| | | | | 10 SLPM | | | between |
| | | | | | | | particles |

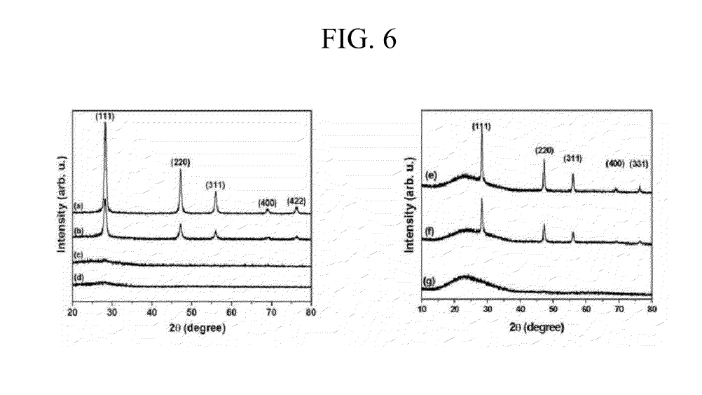

FIG. 6 shows XRD diffraction patterns of the Si nanoparticles produced in the process of manufacturing Si—C composite according to an embodiment of the present disclosure. In Examples 9 and 10, the experimental conditions are described for producing nanoparticles in accordance with the power of RF plasma, and in general, the higher the power will have a higher crystallinity (FIGS. 6(a) and (b)). In Examples 10, 11, and 12, the experimental conditions are described for producing nanoparticles in accordance with the flow rates of doping gas, and the more the flow rate of the doping gas is increased, the more the crystallinity of the particles is decreased (FIGS. 6(b) to (d)). In Example 13 to 15, the experimental conditions are described for controlling the crystallinity of the nanoparticles according to the flow rate of the reactive gas by the apparatus for manufacturing nanoparticles using microwave plasma, and as shown in FIGS. 6(e) to (g), it is possible to control the amorphous and crystalline phases. In general, for amorphous particles, large area of band at 15 to 35° was observed, and for crystalline, peaks corresponding to the cubic Si structure (JCPDS #75-0589) at 28.4, 47.3, 56.1, 69.1 76.3 (28) were observed.

Table 2 below indicates the characteristics of the nanoparticles produced based on plasma source power, plasma forming gas, flow rate of injection gas, kinds of particle precursors, and flow rates of the precursors. As shown from the XRD patterns, Si nanoparticles produced using a plasma torch can be controlled as amorphous or crystalline Si nanoparticles depending on the process conditions (e.g., plasma density, gas partial pressure, residence time, etc.).

TABLE 2

| | Plasma | | | | | | Crystallinity |
|---|---|---|---|---|---|---|---|
| | energy | | Plasma | Injection | Particle | Flow rate of | of resulting |
| | source | Power | forming gas | gas | precursor | precursor | particle |
| EX. 9 | RF (ICP) | 100 W | Ar | Cooled | SiH₄ | 5, 10, 20 | Amorphous |
| | | | 500 ccm | Ar | (vapor) | ccm | |
| | | | | 300 ccm | | | |
| EX. 10 | RF (ICP) | 300 W | Ar | Cooled | SiH₄ | 5, 10, 20 | Meso- |
| | | | 500 ccm | Ar | (vapor) | ccm | crystalline |
| | | | | 300 ccm | | | |
| EX. 11 | RF (ICP) | 300 W | Ar | Cooled | SiH₄ w/ | 5, 10, 20 | High |
| | | | 500 ccm | Ar | PH₃ or H₂ | ccm/ | crystalline |
| | | | | 300 ccm | (vapor) | 5~20 ccm | |
| EX. 12 | RF (ICP) | 300 W | Ar | Cooled | SiH₄ w/ | 5, 10, 20 | Amorphous |
| | | | 500 ccm | Ar | PH₃ or H₂ | ccm/ | |
| | | | | 300 ccm | (vapor) | 25~100 | |
| | | | | | | ccm | |
| EX. 13 | Microwave | 2.5 kW | N₂ | Reactive | SiCl₄ | 1~3 ml/min | Amorphous |
| | (ECR) | | 25 SLPM | H₂ | (liquid) | @RT | |
| | | | | 1 SLPM | | | |
| EX. 14 | Microwave | 2.5 kW | N₂ | Reactive | SiCl₄ | 1~3 ml/min | Crystalline & |
| | (ECR) | | 25 SLPM | H₂ | (liquid) | @RT | Amorphous |
| | | | | 5 SLPM | | | |
| EX. 15 | Microwave | 2.5 kW | N₂ | Reactive | SiCl₄ | 1~3 ml/min | Crystalline |
| | (ECR) | | 25 SLPM | H₂ | (liquid) | @RT | |
| | | | | 10 SLPM | | | |

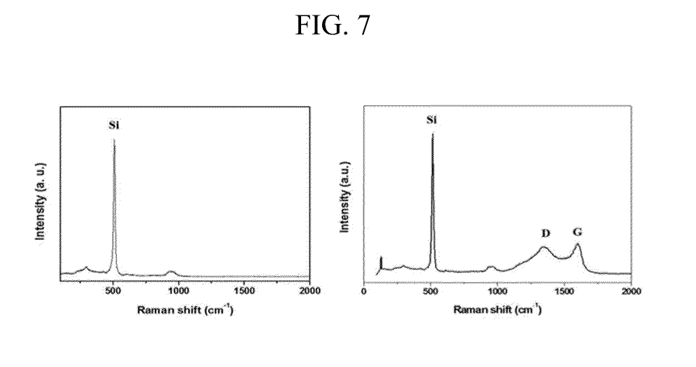

FIG. 7 shows Raman spectra of Si—C composite produced in the process of forming Si—C composite using laser beam at 514 nm according to an embodiment of the present disclosure.

The left Raman spectrum indicates Si nanoparticles produced in a plasma reactor, where a peak corresponding to the crystalline Si nanoparticles at about 520 cm⁻¹ (Si—Si stretching mode, Transverse Optical (TO)), a peak corresponding to Longitudinal Acoustic (LA) of Si particles at 280 to 290 cm⁻¹, and a peak corresponding to a second Transverse Optical (TO) of Si particles at 900 to 930 cm⁻¹ are shown. The right Raman spectrum indicates Si—C composite produced in a plasma reactor, where a peak corresponding to crystalline Si nanoparticles is observed at about 520 cm⁻¹, and a peak corresponding to low crystallinity carbon at 1350 cm⁻¹ (D band; amorphous graphitic material) and a peak corresponding to high crystallinity carbon at 1570 cm⁻¹ (G band; crystalline graphite) are shown.

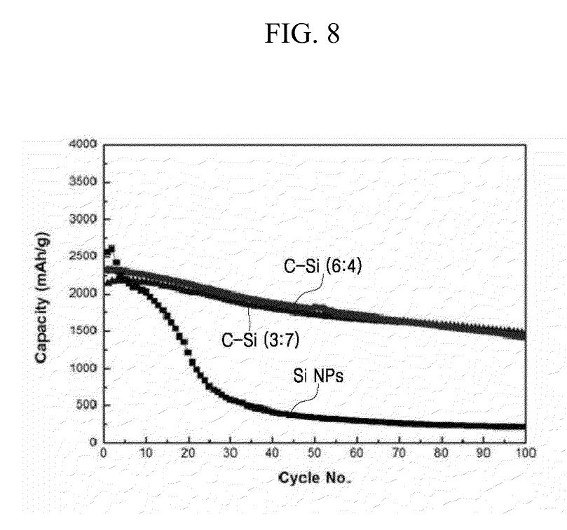

FIG. 8 shows a result of applying the Si nanoparticles (square) and the Si—C composite nanoparticles (circle and triangle) produced using a manufacturing apparatus according to an embodiment of the present disclosure to a negative electrode active material for a lithium secondary battery.

According to the evaluation of the charging and discharging of a negative electrode active material for a secondary battery, in the case of crystalline Si nanoparticles (particle sizes of 80-120 nm), the initial charge capacity was about 2,561 mAh/g, and the initial coulombic efficiency (ICE) was 88.1%. Capacity retention rate after 100 cycles was about 8.1%. In the case of carbon-coated Si—C composite (100˜150 nm), the initial reversible capacity was 2,139 mAh/g, ICE was 85.3%, and the capacity retention rate after 100 cycles was 68.6%, where the initial reversible capacity, ICE and capacity retention rate were all remarkably improved compared to the non-carbon-coated Si nanoparticles (NPs).

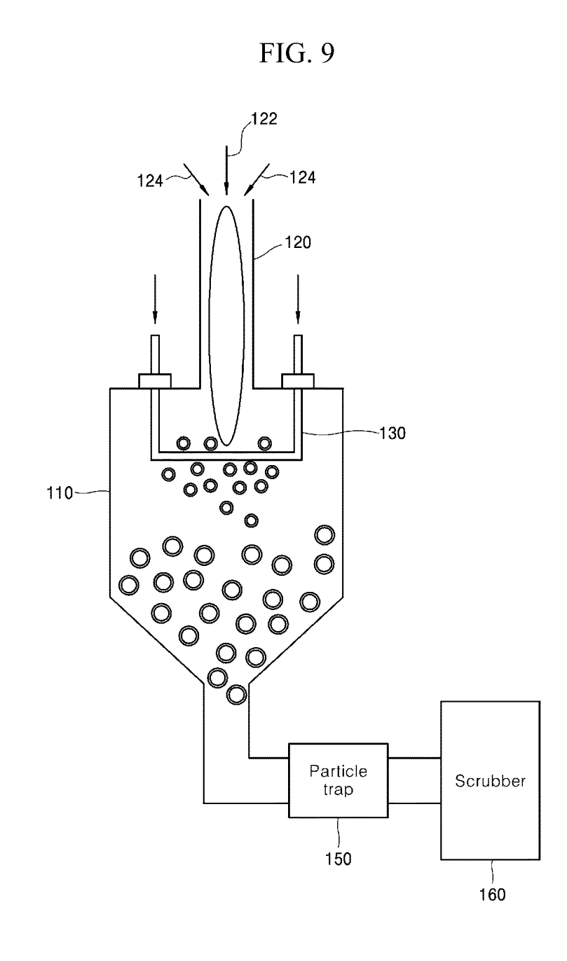

FIG. 9 is a conceptual diagram showing an apparatus for manufacturing silicon-based nanoparticles according to a second embodiment of the present disclosure, and, more specifically, shows an apparatus capable of producing SiOx nanoparticles.

The apparatus of manufacturing silicon-based nanoparticles depicted in FIG. 9 is similar to that depicted in FIG. 1 as a whole. However, the apparatus depicted in FIG. 9 is further provided with a swirl gas inlet 124.

As depicted, the apparatus for manufacturing SiOx nanoparticles according to an embodiment of the present disclosure includes a reaction chamber 110 for providing a reaction space, a microwave plasma torch 120 for generating plasma using a microwave to decompose silicon precursors and produce Si particles, and a cooling part 130 for cooling SiOx nanoparticles so formed, provided within the reaction chamber 110.

The plasma torch 120 is provided on an upper portion of the reaction chamber 110, comprising a precursor gas inlet 122 and a swirl gas inlet 124 for injecting a plasma gas in the form of swirl.

The precursor gas inlet 122 is configured to inject a gas in a vertical direction towards the plasma center, and the swirl gas inlet 124 is configured to inject a swirl gas in a spiral form.

Through the precursor gas inlet 122, silicon precursor, such as solid phase of micro-Si particles or liquid phase of SiCl₄, may be sprayed or gasified, or silicon precursor, such as SiH₄ gas, may be supplied alone or in mixture with a carrier gas, such as argon (Ar) or hydrogen (H₂).

Through the swirl gas inlet 124, plasma gas, such as N₂ or Ar, may be injected, or in mixture with an oxidizing gas.

The oxidizing gas that can be used includes, but not limited to, a mixed gas of hydrogen and oxygen, or air.

Preferably, the plasma gas for forming plasma, such as N₂ or Ar gas, is injected in the form of swirl to the microwave plasma torch 120. When the plasma renders the gas to be injected in the form of swirl, the plasma may be concentrated on the center of the reactor, obtaining a larger volume of high-density plasma zone.

In addition, a particle trap 150 for trapping SiOx particles is provided at a lower portion of the reaction chamber 110, and a scrubber 160 for neutralizing an acid exhaust gas is connected to a lower portion of the particle trap 150.

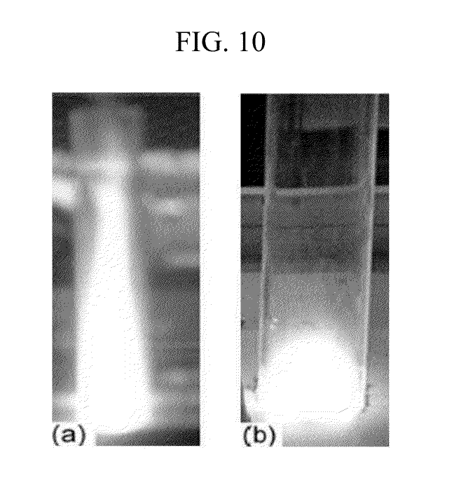

FIG. 10 shows two plasma shapes, (a) when plasma gas is injected in the form of swirl, and (b) when plasma gas is injected vertically.

Referring to FIG. 10, as shown in (a), when the plasma gas is injected in the form of swirl, it forms a vortex flow. The injected source gas is reacted along the vortex flow. As a result, the residence time of the source gas in the plasma zone gets longer, and the reaction efficiency can be improved.

In addition, the vortex flow acts to concentrate the plasma towards the center of the reaction chamber to reduce the contact between the plasma and an inner wall of the torch, such that the contamination of the inner wall of the torch from reagents can be prevented and the overheating of the outer wall of the torch can be protected.

In this embodiment, plasma flame edge can be further reliably controlled, and the plasma gas itself can also be stabilized.

When the plasma gas is injected in the form of swirl, the moving path of the gas in the plasma is formed in the swirl shape, and the residence time of the reactive gas in the plasma gets longer. As a result, it is possible to achieve a sufficient reaction time of the particles, whereby the reaction efficiency can be enhanced.

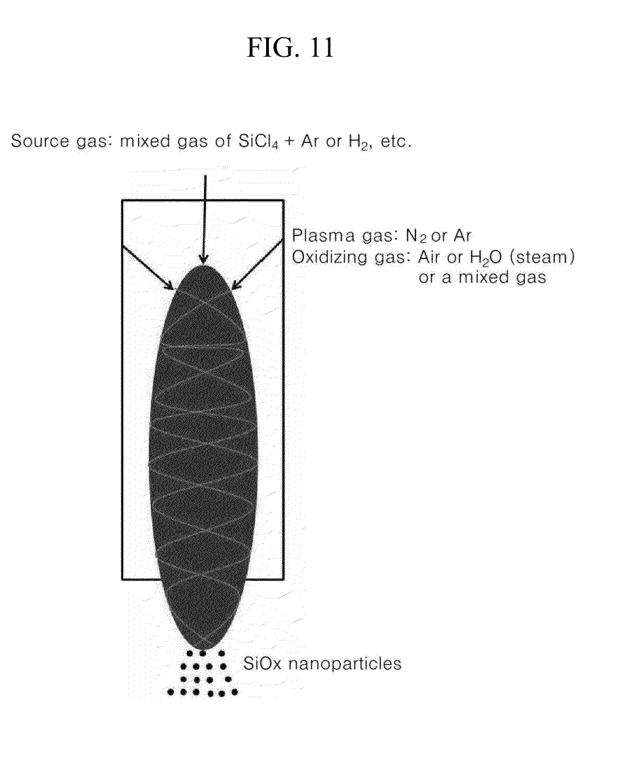

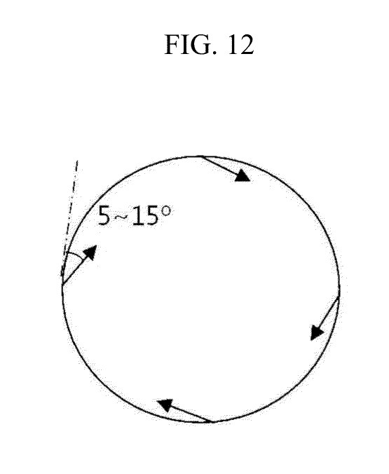

FIG. 11 illustrates an embodiment of the microwave plasma torch according to an embodiment of the present disclosure, and FIG. 12 shows a supply plan view of the plasma gas in the microwave plasma torch according to an embodiment of the present disclosure.

As depicted in FIG. 11, source gas is supplied in a vertical direction toward the center of the plasma zone, and plasma gas is configured to be introduced into the plasma zone with the inclination angle of 25 to 45° with respect to the vertical plane.

Further, the plasma gas, in plan view as shown in FIG. 12, is radially disposed at uniform intervals, and supplied with an angle of 5 to 15° toward the center of the circle in a tangential direction.

The plasma gas that can be used includes, but not limited to, nitrogen or argon gas, and may be supplied together with an oxidizing gas.

The oxidizing gas that can be used includes, but not limited to, air, water vapor (H₂O) or a mixture of these gases.

Plasma gas (or the plasma gas mixed with oxidizing gas) is injected with an inclination to form plasma in the swirl shape, and the source gas moves along this path. As a result, the source gas can have a relatively longer reaction time than non-swirl type of plasma is injected.

Table 3 compares the reaction efficiencies between the case of injecting the plasma gas in the normal mode (vertical direction) and the case of injecting the plasma gas in the swirl mode.

As used herein, the “reaction efficiency” indicates the relative mass percentage of the particles actually obtained, based on the mass where the injected source materials are completely converted into the nanoparticles is taken as 100%.

Plasma power (15 kW) and other process conditions were the same through all the experiments.

TABLE 3

| Plasma | Injection rate | Particle production |
|---|---|---|
| injection mode | (slm) | yield (%) |
| Normal mode | 10 | 15.0 |
| Normal mode | 15 | 17.5 |
| Normal mode | 20 | 19.2 |
| Normal mode | 25 | 20.3 |
| Normal mode | 30 | 21.5 |
| Swirl mode | 10 | 32.5 |
| Swirl mode | 15 | 40.6 |
| Swirl mode | 20 | 51.7 |
| Swirl mode | 25 | 58.9 |
| Swirl mode | 30 | 68.2 |

Referring to Table 3, it can be seen that when injected in the swirl mode, particle production yields greatly increase compared to those injected in the vertical mode. It is believed due to the increased residence time of the source gas in the plasma.

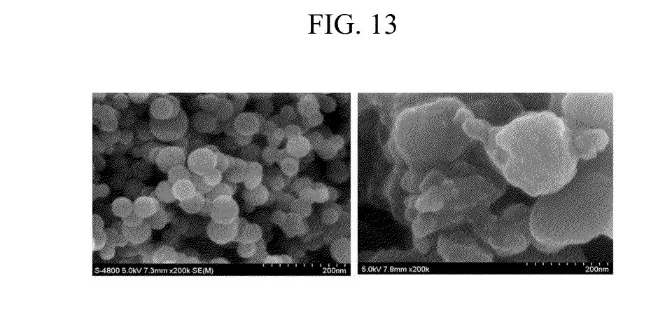

FIG. 13 shows two particle shapes depending on the plasma injection modes.

The left image shows the particles produced when the plasma gas was injected in the swirl mode, and the right image shows the particles when the plasma gas was injected in the normal mode (vertical direction).

The particles synthesized when the plasma gas was injected in the swirl mode show a substantially uniform spherical shape, while the particles synthesized when the plasma gas was injected in the normal mode show aggregates of small particles, rather than have a particular shape. It is believed that the particles were passed through the plasma zone with a wide energy distribution due to microwave plasma having a thermal plasma characteristic.

However, since in the swirl mode the plasma zone was concentrated on the center as depicted in FIG. 11, and the particles were passed through a uniform energy region, the nanoparticles so produced could have a uniform particle shape and avoid an aggregation of the particles.

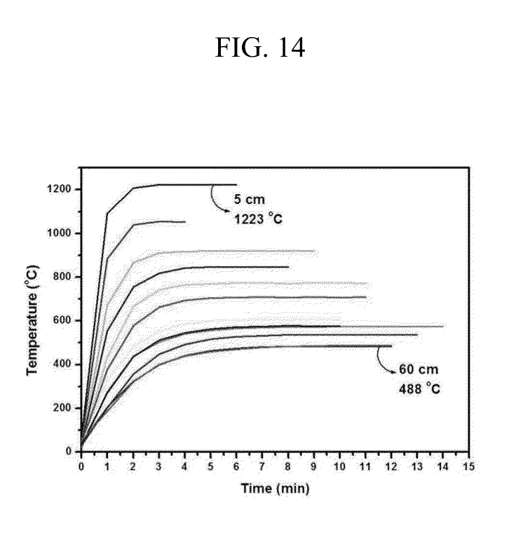

FIG. 14 is a graph showing the internal temperature distributions in a microwave plasma reactor according to an embodiment of the present disclosure.

In FIG. 14, plasma power was measured at 1.5 kW.

According to the temperature distributions, the temperature at a position spaced 60 cm from the plasma was below 500° C., and the temperature at a position spaced 5 cm from the plasma was 1225° C. Due to the measurement limits of the temperature sensor, further measurements at a higher temperature were not possible. However, it can be expected from the temperature changes relative to the plasma power that when forming plasmas at 6.0 kW power, a temperature higher than 3000° C. will be formed at a position spaced 5 from the plasma. The temperature at a maximum density area in a typical microwave plasma was known to be around 3000 to 6000° C.

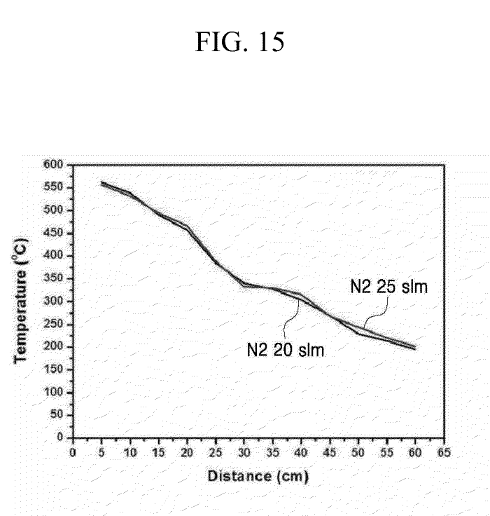

FIG. 15 is a graph showing the temperature distributions outside of the microwave plasma reactor according to an embodiment of the present disclosure.

When each of the plasma gas flow rates of the swirl type of plasma was supplied at 20 slm and 25 slm, the temperature at a position spaced 5 m from the center of the plasma was 550° C. Considering that the internal temperature was 1223° C. at the same position, the temperature difference between the inside and the outside of the reactor amounts to 673° C. Accordingly, it can be seen that since the heat transferred to the reactor can be reduced by concentrating the plasma as the swirl shape, the reactor can be protected from overheating.

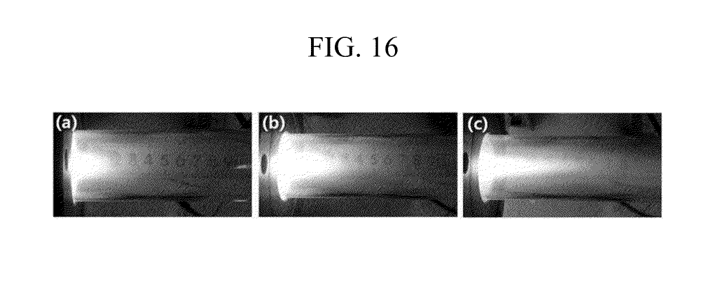

FIG. 16 illustrates variations in the plasma shapes and lengths in accordance with the flow rates of the plasma gas and the flow rates of the reactive gas.

The plasma shapes and lengths are varied by the types of the plasma gas and the reactive gas, and the flow rates thereof. The plasma gas supplied as swirl mode concentrates the plasma on the center.

Further, the plasma shapes and lengths can be determined by the ratios of the flow rates of the reactive gas (or a mixed gas of reactive gas and carrier gas) and the flow rates of plasma gas supplied as swirl mode.

In FIG. 16, (a) shows a plasma when only the swirl mode of plasma gas was injected, (b) shows a plasma when the swirl mode of plasma gas and the reactive gas were injected at the same time, and (c) shows a plasma when an appropriate ratio of between the swirl mode of plasma gas and the reactive gas was injected.

In the case of (a), nitrogen was used as the swirl mode of plasma gas, and 1.5 kW of microwave output was applied at a flow rate of 1 slm.

In the case of (b), the same swirl mode of plasma gas as in (a) was used, and 100 sccm of argon, 1 mL of SiCl₄, and 200 sccm of air were injected as a reactive gas at the output set.

In the case of (C), the same swirl mode of plasma gas as in (a) was used, and the optimal ratio of reactive gas at the output set (Ar:50 sccm, SiCl₄(I):1.5 mL, air:15 sccm) was injected.

SiOx can be produced by employing silicon precursors (e.g., SiCl₄ or SiHCl₃) and oxidizing gas, such as H₂, O₂, air or water vapor (H₂O), alone or in combinations thereof.

When the plasma gas is injected as the swirl mode, it allows for the plasma to be concentrated toward the center. When the plasma is concentrated on the center, the plasma is isolated from an outer wall of the plasma torch, and the outer wall can be prevented from being deformed, etched or damaged due to the overheating. Further, the reactants may be prevented from the contamination by the outer wall of the torch. Moreover, the residence time of the source gas in the plasma can be increased, and the reaction efficiency can be improved. Besides, it is possible to manufacture nanoparticles with a uniform shape and particle size due to the concentrated plasma shape.

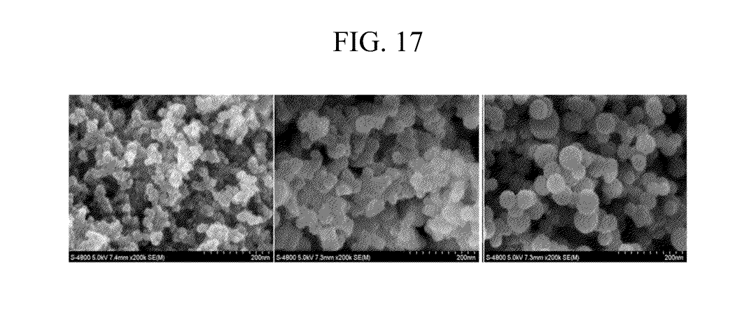

FIG. 17 shows a variety of shapes and sizes of SiOx nanoparticles produced by differentiating a reactive gas, ratios of the reactants, and flow rates thereof.

Referring to FIG. 17, the produced SiOx nanoparticles have a diameter of 25 to 200 nm. As the plasma gas is injected as the swirl shape, relatively uniform shape of particles can be obtained.

The present disclosure provides a method and apparatus capable of producing SiOx nanoparticles having various oxidation numbers. Further, when SiOx nanoparticles produced by the method and apparatus according to the present disclosure are used as a negative electrode active material for a lithium-based secondary battery, the electrical characteristics of the secondary battery can be improved.

In this embodiment, silicon precursor, such as solid Si particles or liquid SiCl₄ is sprayed or gasified, or silicon precursor, such as SiH₄ gas is injected alone or in combination with a carrier gas into the plasma reactor, and oxidizing gas, such as hydrogen, oxygen, and/or water vapor is injected to condense SiOx (x=0.4˜2.0) gas, thereby obtaining nanoparticles.

When only oxygen is used as the oxidizing gas, most of the x values of the particles are close to 2 depending on the injection volume, or unreacted silicon precursor may remain, while when only hydrogen is used as the oxidizing gas, a large amount of trichlorosilane (SiHCl₃) and hydrochloric acid are generated depending on the injection volume, or unreacted silicon precursor may remain.

When injecting a mixture of constant ratio of hydrogen and oxygen, the x values of SiOx nanoparticles can be controlled in a range of 0.4 to 2.0.

Further, even though water vapor (H₂O) is injected, the x values of SiOx nanoparticles can be varied based on the injection volume.

In accordance with the present disclosure, SiOx nanoparticles can be produced to have a variety of crystallinity from a high crystalline phase to a pure amorphous phase.

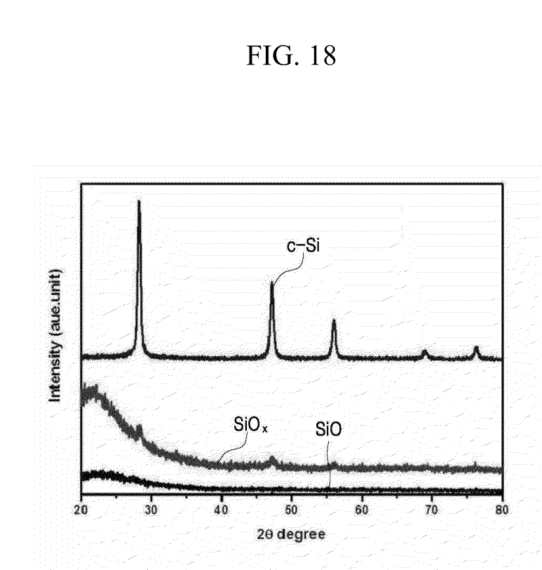

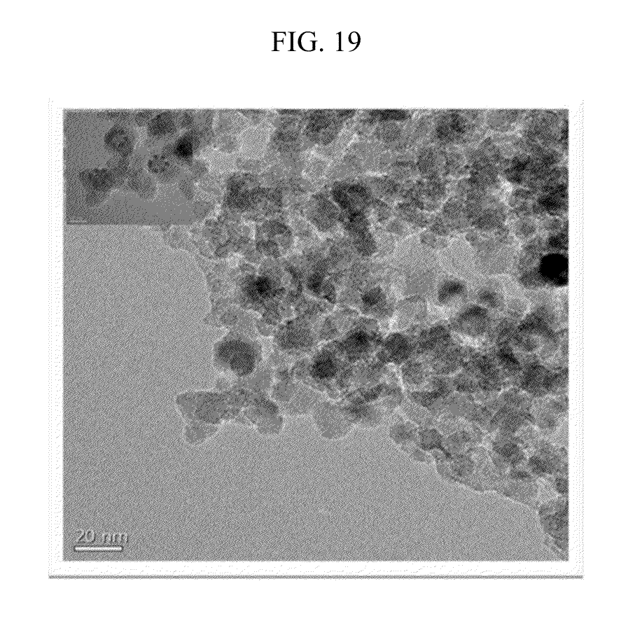

FIGS. 18 and 19 show the crystallinity and microstructure of the SiOx nanoparticles produced in accordance with the present disclosure, respectively.

When the amorphous SiOx nanoparticles are applied to a negative electrode active material for a lithium secondary battery, it can act as a buffer for volume expansion of the silicon occurring during charging and discharging of the battery, thereby obtaining a high charge-discharge capacity and a maintenance performance.

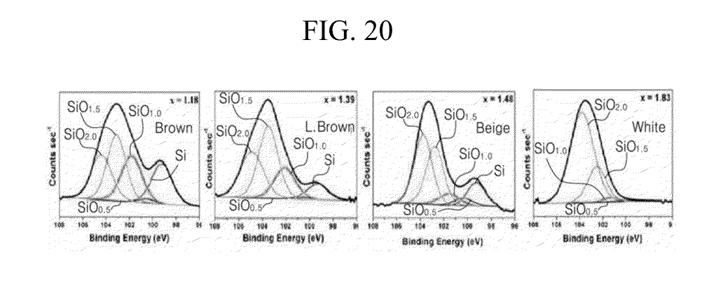

FIG. 20 shows the characteristics of SiOx nanoparticles produced using the device and method according to the present disclosure.

In these embodiments, the air was used as the oxidizing gas, and as shown in the figure, it can be seen that the oxidation numbers of SiOx were varied based on the amount of the air. Further, it can be seen that as the amounts of the air in the total feed gas were varied at 0.15 vol %, 1.00 vol %, 5.00 vol %, and 10.00 vol % from the left, respectively, the resulting oxidizing numbers were changed.

Table 4 shows the oxidation numbers (x value) of SiOx nanoparticles according to the kinds of oxidizing gas and the injection volume.

TABLE 4

| | Injection volume | X |
|---|---|---|
| Oxidizing gas | (vol. %) | (oxidation number) |
| Air | 0.00 | 0.42 |
| Air | 0.075 | 0.81 |
| Air | 0.15 | 1.18 |
| Air | 1.00 | 1.39 |
| Air | 5.00 | 1.48 |
| Air | 10.00 | 1.83 |
| O₂ | 0.02 | 0.8 |
| O₂ | 0.20 | 1.23 |
| O₂ | 2.00 | 1.81 |
| H₂O | 0.50 | 0.52 |
| H₂O | 1.00 | 0.78 |
| H₂O | 2.50 | 0.98 |
| H₂O | 5.00 | 1.16 |

As can be seen from Table 4, the oxidation numbers can be controlled to vary by adjusting the injection volume of the oxidizing gas.

In a negative electrode active material for a secondary battery, silicon has high theoretical capacity of 4200 mAh/g, but due to a rapid volume changes during charging and discharging of the battery, cracks and thick nonconductive films of the cell electrode (solid electrolyte interphase, SEI) are generated (resistance increases sharply), and disrupted away from a current collector, thereby significantly reducing the cycle life characteristics. However, the nano-sized particles of the negative electrode active material and the controlled oxidation number (x value) of SiOx can serve as an effective buffer against the large volume changes of Si-based negative electrode, and lead to improved cycle properties.

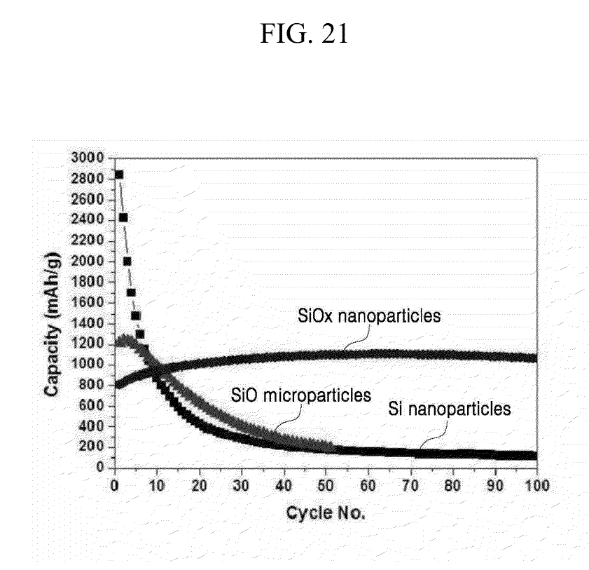

FIG. 21 and Table 5 show the capacity and performance of the secondary battery manufactured by SiOx, crystalline silicon and amorphous SiO, respectively. It is noted that SiOx microparticles or Si nanoparticles give a rapid degradation of capacity, while SiOx nanoparticles produced using the process according to the present disclosure exhibit excellent capacity retention rates.

It is considered that these excellent capacity retention rates are due to the buffering effect of the amorphous SiOx phase against the large volume changes of Si-based negative electrode, as previously mentioned.

TABLE 5

| | Si | SiO | SiOx |
|---|---|---|---|
| | nanoparticles | microparticles | nanoparticles |
| Initial C.E. (%) | 61.00 | 63.01 | 56.84 |
| 1^{st} charge capacity | 2846.91 | 1212.87 | 809.51 |
| (mAh/g) | | | Max. 1103.30 |
| | | | (@66 cycles) |
| Retention rate | 4.00 | 13.77 (@50 cycles) | 130.99 |
| (%, @100 cycles) | | | 96.15 (@66 to |
| | | | 100 cycles) |

Although some embodiments have been provided to illustrate the present disclosure, it will be apparent to those skilled in the art that the embodiments are given by way of illustration, and that various modifications and equivalent embodiments can be made without departing from the spirit and scope of the present disclosure. Accordingly, the scope of the present disclosure should be limited only by the accompanying claims and equivalents thereof.

What is claimed is:

1. An apparatus for manufacturing silicon-based nanoparticles using plasma, comprising:
a reaction chamber for providing a reaction space;
a plasma torch for generating plasma to decompose silicon (Si) precursors and produce Si particles, provided on an upper portion of the reaction chamber;
a cooling part for cooling Si particles supplied into the reaction chamber, provided within the reaction chamber; and
a carbon material supplying part for supplying carbonaceous materials or carbon precursors into the reaction chamber;
wherein in the plasma torch, the Si precursors injected with plasma are dissociated and bonded to form Si particles through particle nucleation and nuclear growth, and wherein in the reaction chamber, the Si particles and the carbonaceous materials are complexed.

2. The apparatus according to claim 1, wherein the carbon material supplying part is connected to the cooling part, such that the carbonaceous materials or the carbon precursors can be supplied.

3. The apparatus according to claim 1, further comprising a particle trap for trapping Si-based nanoparticles, provided at a lower portion of the reaction chamber.

4. The apparatus according to claim 3, further comprising a scrubber for treating an acid exhaust gas, provided at a lower portion of the particle trap.

5. The apparatus according to claim 1, wherein the Si precursors comprises solid micro-Si particles, liquid SiCl₄, sprayed or gasified, or Si H₄ gas.

6. The apparatus according to claim 1, wherein the carbonaceous materials comprise at least one selected from carbon nanotubes (CNT), carbon nanofibers (CNF), and graphite, and the carbon precursors are alcohol or hydrocarbon-based gas.

7. The apparatus according to claim 1, wherein the cooling gas comprises at least one selected from air, nitrogen (N₂), argon (Ar), helium (He), and hydrogen (H₂).

8. An apparatus for manufacturing silicon-based nanoparticles using plasma, comprising:
a reaction chamber for providing a reaction space; and
a microwave plasma torch using a microwave as a plasma source, comprising a precursor gas inlet for injecting a silicon (Si) precursor gas, provided on an upper portion of the reaction chamber, and a swirl gas inlet for injecting a plasma gas in the form of swirl;
wherein the plasma gas and an oxidizing gas are supplied through the swirl gas inlet to allow the oxidizing gas and a source gas to react along a vortex flow.

9. The apparatus according to claim 8, further comprising an oxidizing gas supplying part for supplying the oxidizing gas through the swirl gas inlet.

10. The apparatus according to claim 8, further comprising a cooling part for cooling particles produced in the reaction chamber, provided within the reaction chamber.

11. The apparatus according to claim 8, wherein the swirl gas inlet is radially disposed around the precursor gas inlet, and is configured in such a way that the swirl gas is injected toward the center of the plasma zone in a direction inclined inside at an angle of 25 to 45 degrees with respect to a vertical direction.

12. The apparatus according to claim 11, wherein the swirl gas inlet is configured in such a way that the swirl gas is injected inside toward the center of a circle at an angle of 5 to 15 degrees with respect to a planar tangential direction.

13. The apparatus according to claim 8, further comprising a particle trap for trapping Si-based nanoparticles, provided at a lower portion of the reaction chamber.

14. The apparatus according to claim 13, further comprising a scrubber for treating an acid exhaust gas, provided at a lower portion of the particle trap.

15. The apparatus according to claim 8, wherein the Si precursor gas comprises solid micro-Si particles, liquid SiCl₄, sprayed or gasified, or Si H₄ gas.

16. The apparatus according to claim 8, wherein the plasma gas is nitrogen or argon, and the oxidizing gas is a mixed gas of oxygen and hydrogen, water vapor, or combinations thereof.
